(19) United States
(12) Patent Application Publication
(10) Pub. No.: US 2014/0093779 A1
(43) Pub. Date: Apr. 3, 2014

(54) NEGATIVE-ELECTRODE ACTIVE MATERIAL FOR LITHIUM-ION SECONDARY BATTERY AND PROCESS FOR PRODUCING THE SAME AS WELL AS LITHIUM-ION SECONDARY BATTERY AND PROCESS FOR MANUFACTURING THE SAME

(71) Applicants: Incorporated National University Iwate University, Morioka-shi (JP); Kabushiki Kaisha Toyota Jidoshokki, Kariya-shi (JP)

(72) Inventors: Seung-Taek MYUNG, Morioka-shi (JP); Naoto YASUDA, Kariya-shi (JP); Hitotoshi MURASE, Kariya-shi (JP)

(73) Assignees: Incorporated National University Iwate University, Morioka-shi (JP); Kabushiki Kaisha Toyota Jidoshokki, Kariya-shi (JP)

(21) Appl. No.: 14/072,197

(22) Filed: Nov. 5, 2013

Related U.S. Application Data
(63) Continuation-in-part of application No. PCT/JP2012/002902, filed on Apr. 27, 2012.

(30) Foreign Application Priority Data
May 6, 2011 (JP) 2011-103765

(51) Int. Cl. H01M 4/485; C01B 11/24

(52) U.S. Cl. CPC H01M 4/485; C01B 11/24
USPC 429/231.5; 423/472

(57) ABSTRACT

An object of the present invention is to provide a negative-electrode active material for lithium-ion secondary battery, negative-electrode active material which makes it possible for lithium-ion secondary batteries to exhibit higher capacities, and which makes it feasible to charge and discharge lithium-ion secondary batteries at a faster speed. In a production process according to the present invention, oxidized titanium fluoride is obtained by heating a mixed raw material, which includes a mixture of anatase-type TiO₂ and hydrofluoric acid, at 70° C. or more (i.e., a heating step). This mixed raw material includes hydrogen fluoride in an amount exceeding 2 mol per the anatase-type TiO₂ making 1 mol. When the oxidized titanium fluoride, which is obtained by this production process, is used as a negative-electrode active material of lithium-ion secondary battery, high-capacity and rapidly-chargeable/dischargeable lithium-ion secondary batteries are obtainable.

### CROSS REFERENCE TO RELATED APPLICATIONS

This application is a Continuation In Part of International Application No. PCT/JP2012/002902 filed Apr. 27, 2012, claiming priority based on Japanese Patent Application No. 2011-103765 filed May 6, 2011, the contents of all of which are incorporated herein by reference in their entirety.

### TECHNICAL FIELD

The present invention is one which relates to a process for producing a negative-electrode active material for lithium-ion secondary battery and to a negative-electrode active material that is produced by this production process, as well as to a process for manufacturing a lithium-ion secondary battery in which this negative-electrode active material is used and to a lithium-ion secondary battery in which this negative-electrode active material is used.

### BACKGROUND ART

Since lithium-ion secondary batteries have a smaller size and a larger capacity, they have been used widely as a secondary battery for cellular phones, notebook-size personal computers, and so forth. Recently, proposals have also been made for intents and purposes for their use as a battery for electric automobiles, hybrid automobiles, and so on.

A lithium-ion secondary battery possesses an active material, which can insert (or sorb) lithium (Li) into itself and eliminate (or desorb) the same from itself, in the positive electrode and negative electrode, respectively. The lithium-ion secondary battery operates by means of the migrations of lithium ions between the two electrodes.

It has been required to make lithium-ion secondary batteries exhibit higher capacities, and to make them produce higher outputs. In order to upgrade these characteristics, using Li₄Ti₅O₁₂ with a spinel structure as a negative-electrode active material has been proposed (see Patent Literature No. 1, for instance). However, the capacity of Li₄Ti₅O₁₂ is not so large, because it is 170 mAh/g approximately. Consequently, negative-electrode active materials, which furthermore enable lithium-ion secondary batteries to exhibit higher capacities, have been desired. Among negative-electrode active materials including titanium (Ti), TiO₂ has been getting a great deal of attention recently, because it is inexpensive, and because it is feasible to charge and discharge it at a faster speed.

As for the structures of TiO₂, a plurality of them, such as a rutile type and an anatase type, have been known. Among these, anatase-type TiO₂ has been said to be better in terms of the reversibility comparatively, and to have higher capacities. However, it has been difficult to manufacture high-capacity and rapidly-chargeable/dischargeable lithium-ion secondary batteries by only using anatase-type TiO₂ simply as a negative-electrode active material.

### RELATED TECHNICAL LITERATURE

### Patent Literature

Patent Literature No. 1: Japanese Unexamined Patent Publication (KOKAI) Gazette No. 2009-199793

### SUMMARY OF THE INVENTION

### Assignment to be Solved by the Invention

The present invention is one which has been done in view of the circumstances being aforementioned. It is therefore an object to provide a negative-electrode active material for lithium-ion secondary battery, negative-electrode active material which includes Ti and which enables lithium-ion secondary batteries to furthermore exhibit higher capacities and to be chargeable and dischargeable at a faster speed when being used as the negative-electrode active material, and to provide a process for producing the same; as well as to provide a lithium-ion secondary battery that uses the present negative-electrode active material, and to provide a process for manufacturing the same.

### Means for Solving the Assignment

The inventors of the present invention found out, as a result of their earnest studies, that lithium-ion secondary batteries, which have higher capacities and which are chargeable and dischargeable at a faster speed, are obtainable by fluorinating anatase-type TiO₂ with use of hydrofluoric acid, and then using the thus obtained oxidized titanium fluoride as a negative-electrode active material.

Specifically, a process according to the present invention, which solves the aforementioned assignment, for producing a negative-electrode active material for lithium-ion secondary battery is characterized in that:

the process is equipped with a heating step of obtaining oxidized titanium fluoride by heating a mixed raw material, which includes a mixture of anatase-type TiO₂ and hydrofluoric acid, at 70° C. or more; and

the mixed raw material includes hydrogen fluoride (HF) in an amount exceeding 2 mol per the anatase-type TiO₂ making 1 mol.

A negative-electrode active material for lithium-ion secondary battery according to the present invention that solves the aforementioned assignment is characterized in that:

the negative-electrode active material includes titanium (Ti), and fluorine (F); and

a content of fluorine (F) per 1-mol titanium (Ti) exceeds 1 mol.

Moreover, another negative-electrode active material for lithium-ion secondary battery according to the present invention that solves the aforementioned assignment is characterized in that:

the negative-electrode active material is produced by the process for producing a negative-electrode active material for lithium-ion secondary battery according to the present invention;

the negative-electrode active material includes titanium (Ti), and fluorine (F); and

a content of fluorine (F) per 1-mol titanium (Ti) exceeds 1 mol.

Moreover, a lithium-ion secondary battery according to the present invention that solves the aforementioned assignment is characterized in that the lithium-ion secondary battery includes one of the negative-electrode active materials for lithium-ion secondary battery according to the present invention in a negative electrode.

Moreover, a process for manufacturing a lithium-ion secondary battery according to the present invention that solves the aforementioned assignment is characterized in that the oxidized titanium fluoride, which is produced by the process for producing a negative-electrode active material for lithium-ion secondary battery according to the present invention, is used as a negative-electrode active material.

### Effect of the Invention

Hereinafter, the process for producing a negative-electrode active material for lithium-ion secondary battery according to the present will be simply abbreviated to as a “production process” according to the present invention. Moreover, the negative-electrode active materials for lithium-ion secondary battery according to the present invention will be simply abbreviated to as “negative-electrode active materials” according to the present invention.

In accordance with the production process according to the present invention, it is possible to produce negative-electrode active materials that enable lithium-ion secondary batteries to exhibit higher capacities, and which enable them to be chargeable and dischargeable at a faster speed. Moreover, in accordance with the negative-electrode active materials according to the present invention, it is possible to make lithium-ion secondary batteries exhibit higher capacities, and to make them chargeable and dischargeable at a faster speed. In addition, it is feasible for the lithium-ion secondary battery according to the present invention to have higher capacities, and to be capable of charging and discharging at a faster speed.

### BRIEF DESCRIPTION OF THE DRAWINGS

FIG. 1 is a graph that shows charging and discharging curves of a lithium-ion secondary battery according to an example;

FIG. 2 is a graph that shows a cyclability of the lithium-ion secondary battery according to the example;

FIG. 3 is a graph that shows charging and discharging curves of a lithium-ion secondary battery according to Comparative Example No. 1;

FIG. 4 is a graph that shows rate characteristics of the lithium-ion secondary battery according to the example;

FIG. 5 is a graph that shows rate characteristics of the lithium-ion secondary battery according to Comparative Example No. 1;

FIG. 6 is an SEM image of a negative-electrode active material according to the example;

FIG. 7 is a graph that shows results of subjecting the negative-electrode active material according to the example to an XRD analysis;

FIG. 8 is a graph that shows results of subjecting the negative-electrode active material according to the example to an XRD analysis in each stage at the time of the first-round discharging;

FIG. 9 is an enlarged diagram for a major section in FIG. 8;

FIG. 10 is a graph that shows results of subjecting the negative-electrode active material according to the example to an XRD analysis in each stage at the time of the first-round charging;

FIG. 11 is a graph that shows results of subjecting the negative-electrode active material according to the example to an XPS analysis in each stage at the time of the first-round discharging;

FIG. 12 is a graph that shows results of subjecting the negative-electrode active material according to the example to an XPS analysis in each stage at the time of the first-round charging;

FIG. 13 is a graph that shows results of subjecting the negative-electrode active material according to the example to an XPS analysis in each stage at the time of the second-round discharging;

FIG. 14 is a graph that shows results of subjecting the negative-electrode active material according to the example to an XRD analysis in each stage at the time of the second-round charging;

FIG. 15 is an explanatory diagram that shows structural changes of the negative-electrode active material according to the example in each stage at the time of the first-round discharging;

FIG. 16 is electron diffraction images of the negative-electrode active material in such respective stages as Initial Discharging Stage “A” (e.g., 3 V), Intermediate Discharging Stage “B” (e.g., 0.93 V), and Terminal Discharging Stage “C” (e.g., 0.25 V);

FIG. 17 is a TEM image of the negative-electrode active material in Terminal Discharging Stage “C”;

FIG. 18 is another TEM image of the negative-electrode active material in Terminal Discharging Stage “C”;

FIG. 19 is a graph for showing results of subjecting the negative-electrode active material, which is illustrated in FIG. 17, in Terminal Discharging Stage “C” to an EDX analysis;

FIG. 20 is a graph for showing results of subjecting the negative-electrode active material, which is illustrated in FIG. 18, in Terminal Discharging Stage “C” to the EDX analysis;

FIG. 21 is a diagram for showing a crystal structure of TiOF₂ in the negative-electrode active material; and

FIG. 22 is a diagram for showing crystal structures of Ti^{IV}OF₂, LiTi^{III}OF₂ and Ti^{II}O in the negative-electrode active material, respectively.

### MODES FOR CARRYING OUT THE INVENTION

In a production process according to the present invention, anatase-type TiO₂, and hydrofluoric acid (i.e., an aqueous solution of hydrogen fluoride) are used. Hereinafter, unless otherwise specified, the term, anatase-type TiO₂, will be simply abbreviated to as “TiO₂.”

As for the anatase-type TiO₂, it is allowable to use those which have been produced by known processes. For example, it has been known that the anatase-type TiO₂ can be produced by processes which are called a uniform precipitation method and hydrothermal method. The uniform precipitation method is a process for causing a precipitate to generate uniformly in a reaction liquid entirely by means of chemical reactions, and the following have been known: positive-ion emission methods (e.g., oxidation-reduction methods, and complex decomposition methods), negative-ion emission methods (e.g., urea hydrolysis methods, amide hydrolysis methods, ester hydrolysis methods, and oxidation-reduction methods), and the like. Among these, since a urea decomposition method makes it possible to produce fine anatase-type TiO₂ with 1 μm-or-less particle diameters, it is suitable for producing the anatase-type TiO₂ that makes a raw material of the negative-electrode active material. For reference, urea hydrolysis methods are respectively a process for causing an objective substance to precipitate by heating urea to do the hydrolysis in order to cause ammonia to generate in the reaction liquid, and then gently changing a pH of the reaction liquid. Note that the anatase-type TiO₂ being used in the present invention is not at all limited to those which are produced by this process, but it is even permissible that the anatase-type TiO₂ can also be those which are produced by any other processes.

Although it is allowable that the hydrofluoric acid can be capable of fluorinating the anatase-type TiO₂, a preferable range exists for a concentration of hydrogen fluoride in the mixed raw material as described later. To be concrete, it is permissible that hydrogen fluoride (HF) in the mixed raw material can be included in an amount exceeding 2 mol per TiO₂ that makes 1 mol. When the amount of hydrogen fluoride in the mixed raw material falls within this range, TiOF₂ can be fluorinated sufficiently, so that it is possible to obtain oxidized titanium fluoride. Note that it is preferable that hydrogen fluoride (HF) in the mixed raw material can make 2 mol or more per TiO₂ that makes 1 mol, and it is more preferable that it can make 10 mol or more. Oxidized titanium fluoride being obtained by this process has particulate shapes. It is preferable that particle diameters of particles of oxidized titanium fluoride serving as the negative-electrode active material can be the smaller the better. When particle diameters of the negative-electrode active material are smaller, it is possible to give faster-speed chargeable/dischargeable characteristics to lithium-ion secondary batteries, because the migration distance of Li can be managed to be shorter at the time of charging and discharging them. Preferably, it is advisable that the resulting oxidized titanium fluoride can have fine particulate shapes with particulate diameters of from 1 nm to 50 nm approximately.

A negative electrode for lithium-ion secondary battery according to the present invention includes the negative-electrode active material being described above. This negative electrode has a current collector, and an active-material layer being bound on the current collector. Other than the negative-electrode active material, the active-material layer is able to include known materials, such as conductive additives and binder resins, which constitute negative-electrode materials. It is possible to fabricate the negative electrode in a lithium-ion secondary battery according to the present invention by means of the following steps: coating one, which have been turned into a slurry by adding an organic solvent to these materials and then mixing them one another, onto the negative-electrode active material by such a method as roll coating methods, dip coating methods, doctor blade methods, spray coating methods and curtain coating methods; and then causing the binder resin to cure.

As for the current collector, although it is possible to employ such a configuration as foils and plates, it is not limited especially at all as far as it has a configuration that complies with purposes. As the current collector, copper foils, aluminum foils, and the like, can be used, for instance.

A conductive additive is added in order to enhance the conductivity of electrode. As the conductive additive, it is possible to add one of the following independently, or to combine two or more members of the following to add: carbon black (or CB), acetylene black (or AB) and KETJENBLACK (or KB), namely, carbonaceous fine particles; or gas-phase-method carbon fibers (or vapor grown carbon fibers (or VGCF)), and so forth. Although it is not restrictive especially at all as to an employed amount of the conductive additive, it can be set in general at from 20 to 100 parts by mass with respect to 100 parts by mass of the negative-electrode active material.

The binder resin is used as a binding agent for binding the negative-electrode active material and conductive additive onto the current collector. It is required that the binder resin fasten the negative-electrode active material, and so on, in an amount as small as possible. It is preferable that a compounded amount of the binder resin can be from 0.5 to 50% by mass when a summed amount of the negative-electrode active material, conductive additive and binder resin is taken as 100% by mass. When an amount of the binder resin is less than 0.5% by mass, the formability of the resulting electrode declines; whereas, when it exceeds 50% by mass, the energy density of the resultant electrode becomes lower. Although a type of the binder resin is not restrictive at all, the following can be exemplified: fluorine-based polymers, such as polyvinylidene fluoride (or PVDF) and polytetrafluoroethylene (or PTFE); rubbers, such as stylene-butadiene rubber (or SBR); imide-based polymers, such as polyimide; alkoxysilyl group-containing resins; polyacrylic acids (or PAA); polymethacrylic acids; polyitaconic acids, and the like.

It is possible for a lithium-ion secondary battery according to the present invention using the negative electrode being aforementioned to use a known positive electrode, electrolytic solution, and separator that are not limited especially at all. It is allowable that the positive electrode can be those which are employable in lithium-ion secondary batteries. The positive electrode has a current collector, and a positive-electrode active-material layer being bound on the current collector. It is even permissible that the positive-electrode active-material layer can include a positive-electrode active material, and a binder; and can further include a conductive additive as well. The positive-electrode active material, conductive additive and binder are not limited especially at all, and it is advisable that they can be those which are employable in lithium-ion secondary batteries.

As for the positive-electrode active material, the following can be given: Li“M”O₂ (note, however, that “M” is at least one member being selected from the group consisting of Ni, Co and Mn, and that, in a case where “M” includes a plurality of members being selected from this group, a sum of them makes 1); spinel-type lithium manganese oxides being expressed by Li₁₊ₓMn_{2-x-y}“M”_{y}O₄; LiFePO₄; LiMnPO₄, and so forth. For the current collector, it is allowable to use those which have been common as a current collector for the positive electrode of lithium-ion secondary batteries. For the conductive additive and binder, it is possible to use the same constituent elements as those which have been set forth in the above-mentioned negative electrode.

Although the electrolytic solution is not limited especially at all, it is preferable to use those in which an Li metallic salt, namely, an electrolyte, has been caused to dissolve in an organic solvent. As the organic solvent, it is possible to use one or more members being selected from nonprotonic organic solvents, such as propylene carbonate (or PC), ethylene carbonate (or EC), dimethyl carbonate (or DMC), diethyl carbonate (or DEC) and ethyl methyl carbonate (EMC). Moreover, as for an electrolyte to be caused to dissolve, it is possible to use Li metallic salts being soluble in organic solvents, such as LiPF₆, LiBF₄, LiAsF₆, LiI, LiClO₄ and LiCF₃SO₃.

For example, it is possible to employ a solution in which an Li metallic salt, such as LiClO₄, LiPF₆, LiBF₄ or LiCF₃SO₃, has been caused to dissolve in an organic solvent, such as ethylene carbonate, dimethyl carbonate, propylene carbonate or diethyl carbonate, in a concentration of from 0.5 mol/L to 1.7 mol/L approximately.

The separator is not limited especially at all as far as it can be those which can be employed for lithium-ion secondary batteries. The separator is one which separates a positive electrode from a negative electrode or vice versa, and retains an electrolytic solution therein. It is possible to use thin microporous films, such as polyethylene and polypropylene, therefor.

The lithium-ion secondary battery according to the present invention is not limited especially at all in terms of the configuration, so that it is possible to employ a variety of configurations, such as cylindrical types, laminated types and coin types. Even in a case where any one of the configurations is adopted, a battery is made as follows: the separators are interposed between the positive electrodes and the negative electrodes, thereby making electrode assemblies; and then these electrode assemblies are sealed hermetically in a battery case along with the electrolytic solution after connecting intervals to and from the positive-electrode terminals and negative-electrode terminals, which lead to the outside from the resulting positive-electrode current collectors and negative-electrode current collectors, with use of leads for collecting current, and the like.

Hereinafter, the present invention will be explained in more detail while giving a specific example.

### EXAMPLE

### Example No. 1

### Manufacture of Lithium-ion Secondary Battery

### Synthesis of Anatase-type TiO₂

A mixture, in which distilled water, titanium tetrachloride, urea, ammonium sulfate and ethanol had been mixed one another in a ratio of 4:0.99:1:0.01:4 by mass, was stirred in an ice bath for 2 hours.

The post-stirring mixture was subjected to a hydrothermal treatment at 120° C. for 5 hours. After the hydrothermal treatment, the resulting solid contents were washed with distilled water, and were then dried at 80° C. for 12 hours, thereby obtaining anatase-type TiO₂. The obtained anatase-type TiO₂ was nanometer-size particles whose average particle diameter was about 30 nm approximately.

### Synthesis of Oxidized Titanium Fluoride

The TiO₂ nanometer-size particles being obtained by the above-mentioned step, and a 46%-by-mass HF solution were mixed one another in a ratio of TiO₂:HF=1:10 by mol, thereby obtaining a mixed raw material. This mixed raw material was stirred at 80° C. for 24 hours. The post-stirring mixed raw material was heated at 80° C. under reduced pressure (i.e., a heating step). This heating step was carried out until volatile components, such as the solvents (e.g., water), had volatilized. Note that, in a case where the heating step is carried out at 80° C. or less (at 70° C., for instance), the heating time can be made longer. By means of the heating step, TiO₂ and HF in the mixed raw material reacted with each other so that oxidized titanium fluoride generated. It is believed that this oxidized titanium fluoride could possibly be TiOF₂ as described below. Thereafter, the solid contents were washed with distilled water, and then particulate-shaped oxidized titanium fluoride was obtained by drying them at 80° C. for 12 hours. This particulate-shaped oxidized titanium fluoride was also nanometer-size particles whose particle diameters were from about 5 nm to 40 nm approximately. The oxidized titanium fluoride being obtained by this step was a negative-electrode active material according to an example.

### Negative Electrode

80 parts by mass of the negative-electrode active material being obtained by the above-mentioned steps, 7.5 parts by mass of CB (e.g., “Super-P,” a product of TIMCAL GRAPHITE AND CARBON Corporation) serving as a conductive additive, and graphite (e.g., “KS6”) serving as another conductive additive, and 5 parts by mass of PAA serving as a binder were mixed one another, thereby preparing a negative-electrode mixture material. This negative-electrode mixture material was coated onto a surface of an aluminum foil with 20 μm in thickness so as to make a thickness of 50 μm, and was then dried at 120° C. for 8 hours. After the drying, the aluminum foil with the negative-electrode mixture material coated was punched out to a predetermined configuration, thereby obtaining a negative electrode having a 10×10 mm-squared shape and a thickness of 70 μm.

### Other Constitutions

For the counter electrode (i.e., the positive electrode), a metallic lithium foil whose shape was a 2×2 mm square and thickness was 70 μm was used. For the electrolytic solution, a mixture solution was used which comprised: a mixed solvent including EC (i.e., ethylene carbonate), DMC (i.e., dimethyl carbonate) and EMC (i.e., ethyl methyl carbonate) in a ratio of EC:DMC:EMC=1:1:1 by volume; and “LiBETI” (i.e., a lithium imide electrolyte (e.g., Li(C₂F₅SO₂)₂N)) being dissolved in the mixed solvent in a concentration making 1 mol/L. Note that the “LiBETI” was added in order to prevent alloying from occurring between aluminum within the aluminum foil and lithium.

### Lithium-Ion Secondary Battery

With use of the above-mentioned positive electrode and negative electrode, a laminated square cell was manufactured. Specifically, a rectangle-shaped sheet, which comprised a polypropylene resin and whose shape was a 40×40 mm square and thickness was 30 μm, was interposed or held between the positive electrode and the negative electrode as a separator to make a polar-plate subassembly. This polar-plate subassembly was covered with laminated films in which two pieces made a pair. After sealing the laminated films at the three sides, the above-mentioned electrolytic solution was then injected into the laminated films which had been turned into a bag shape. Thereafter, the remaining one side was sealed, thereby obtaining a laminated cell whose four sides were sealed air-tightly and in which the polar-plate subassembly and electrolytic solution were closed hermetically. Note that the positive electrode and negative electrode were provided with a tab being electrically connectable to the outside, respectively, and that the tabs extended out partially to the outside of the resulting laminated cell. A laminated-cell-shaped (or bipolar pouched cellular) lithium-ion secondary battery was obtained by those steps as above.

### Comparative Example No. 1

A lithium-ion secondary battery was manufactured in the same manner as the present example, except that TiO₂, which was identical with that was used in the present example, was used as the negative-electrode active material.

### Comparative Example No. 2

A production process according to Comparative Example No. 2 was the same process as that in the present example, except for a HF concentration in the mixed raw material. Specifically, in Comparative Example No. 2, the mixed raw material was obtained by mixing the same TiO₂ nanometer-size particles as those in the present example and a 46%-by-mass HF solution one another in such a ratio as TiO₂:HF=1:2 by mol when synthesizing oxidized hydrogen titanium, namely, a negative-electrode active material. Other than this, the production process was identical with that in the present example. Moreover, a lithium-ion secondary battery according to Comparative Example No. 2 was one which was identical with that according to the present example, except for the negative-electrode active material.

### Charging and Discharging Characteristics of Lithium-Ion Secondary Batteries

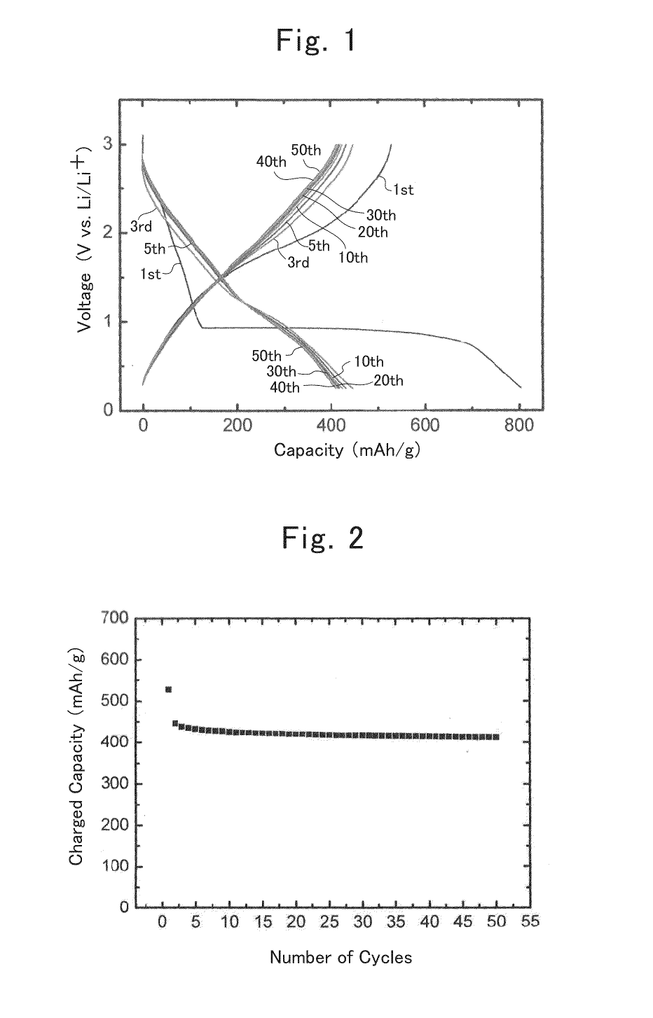

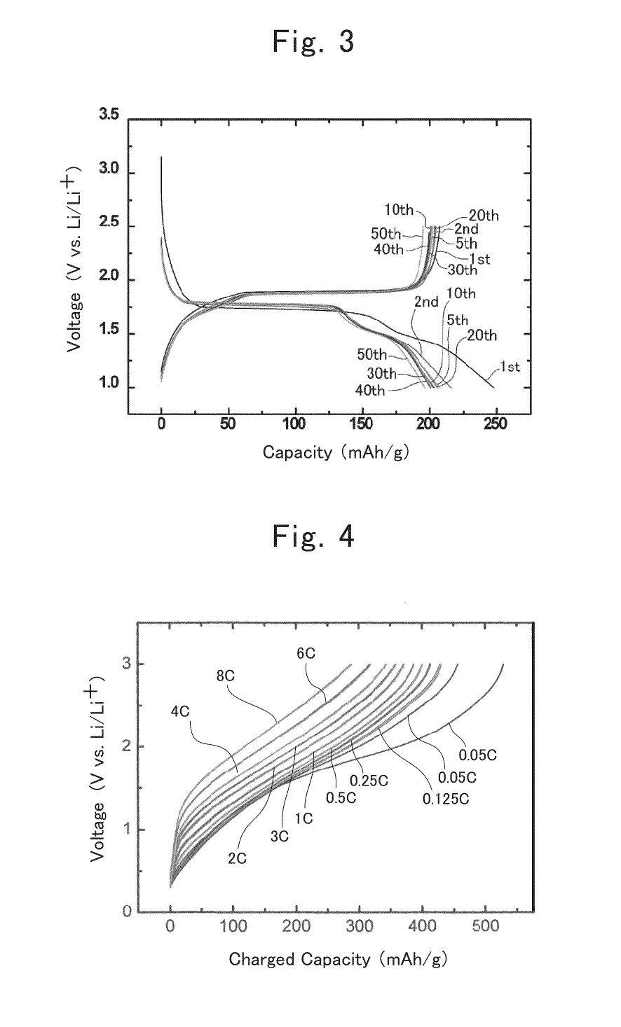

A charging/discharging test was carried for lithium-ion secondary batteries according to the above described present example and Comparative Example Nos. 1 through 2. The charging/discharging conditions were as follows: a constant current (e.g., 20 mA/g); voltage range of from 0.25 to 3.0 V; and 30° C. measurement temperature. The term, “charging,” specifies the direction in which an active material in an electrode to be evaluated sorbs Li; whereas the term, “discharging,” specifies the other direction in which the active material in the electrode to be evaluated desorbs Li. Results of the charging/discharging test are illustrated in FIGS. 1 through 3. Note that FIG. 1 is a graph for showing charging and discharging curves of the lithium-ion secondary battery according to the present example. FIG. 2 is a graph for showing a cyclability of the lithium-ion secondary battery according to the present example. FIG. 3 is a graph for showing charging and discharging curves of the lithium-ion secondary battery according to Comparative Example No. 1.

As illustrated in FIG. 1, the charging and discharging curves of the lithium-ion secondary battery according to the present example differed greatly between the first-round cycle and the second-round cycle or later. To be concrete, in the first-round cycle, the discharged capacity (i.e., the initial discharged capacity) was 800 mAh/g, and the charged capacity (i.e., the initial charged capacity) was 535 mAh/g. In the second-round cycle, the discharged capacity and charged capacity were about 450 mAh/g, respectively, and they were substantially identical values one another in the third-round cycle or later. Moreover, being distinct to the first-round cycle alone, however, a long plateau (i.e., a high-level stability) occurred at around 1.0 V. From these results, it is believed that, in the negative-electrode active material in the lithium-ion secondary battery according to the present example, reactions of some sort arose at the time of the first-round discharging. And, since no great change could be seen in the capacities at the time of the discharging in the second-round cycle or later, it is presumed that the reactions included a conversion reaction.

However, the charged and discharged capacities of the lithium-ion secondary battery according to the present example were large enough to be 400 mAh/g approximately even in the second-round cycle or later. Therefore, it is possible to say that the lithium-ion secondary battery according to the present example had higher capacities. And, it is possible to say that the negative-electrode active material according to the present example can turn lithium-ion secondary batteries into higher-capacity ones.

Moreover, as illustrated in FIG. 2, the lithium-ion secondary battery according to the present example was better in terms of the cyclability as well, because the capacities hardly declined (e.g., from about 400 mAh/g) even after 50 cycles.

On the contrary, the capacities of the lithium-ion secondary battery according to Comparative Example No. 1 were 200 mAh/g approximately, and the capacities of the lithium-ion secondary battery according to Comparative Example No. 2 were 350 mAh/g approximately. Compared with the capacities of the lithium-ion secondary battery according to Comparative Example No. 1, the capacities of the lithium-ion secondary batteries according to the present example and Comparative Example No. 2 were large. From this result, it is understood that, not using simple anatase-type TiO₂ as a negative-electrode active material, but using oxidized titanium fluoride, which is made by fluorinating anatase-type TiO₂, as a negative-electrode active material makes it possible to turn lithium-ion secondary batteries into higher-capacity ones. Moreover, the lithium-ion secondary battery according to the present example, whose mixed raw material included TiO₂ and hydrogen fluoride (HF) in a ratio of 1:10 by mol, had far higher capacities than had the lithium-ion secondary battery according to Comparative Example No. 2, whose mixed raw material included TiO₂ and hydrogen fluoride (HF) in a ratio of 1:2 by mol. It is understood that lithium-ion secondary batteries can be turned into higher-capacity ones by using those which include hydrogen fluoride (HF) in an amount exceeding 2 mol per 1-mol TiO₂ as the mixed raw material. Moreover, it is understood that those which include hydrogen fluoride (HF) in amount of 5 mol or more per 1-mol TiO₂ can preferably be used as the mixed raw material, and that those which include hydrogen fluoride (HF) in amount of 10 mol or more per 1-mol TiO₂ can more preferably be used as the mixed raw material. Note that, when an amount of hydrogen fluoride in the mixed raw material is too little (e.g., from 0.01 to 2 mol), it is believed that it is less likely to turn lithium-ion secondary batteries into higher-capacity ones, because TiO₂ cannot be fluorinated sufficiently and thereby oxidized titanium fluoride and TiO₂ are put in a state in which they are intermingled with each other.

### Rate-Characteristic Evaluation Test

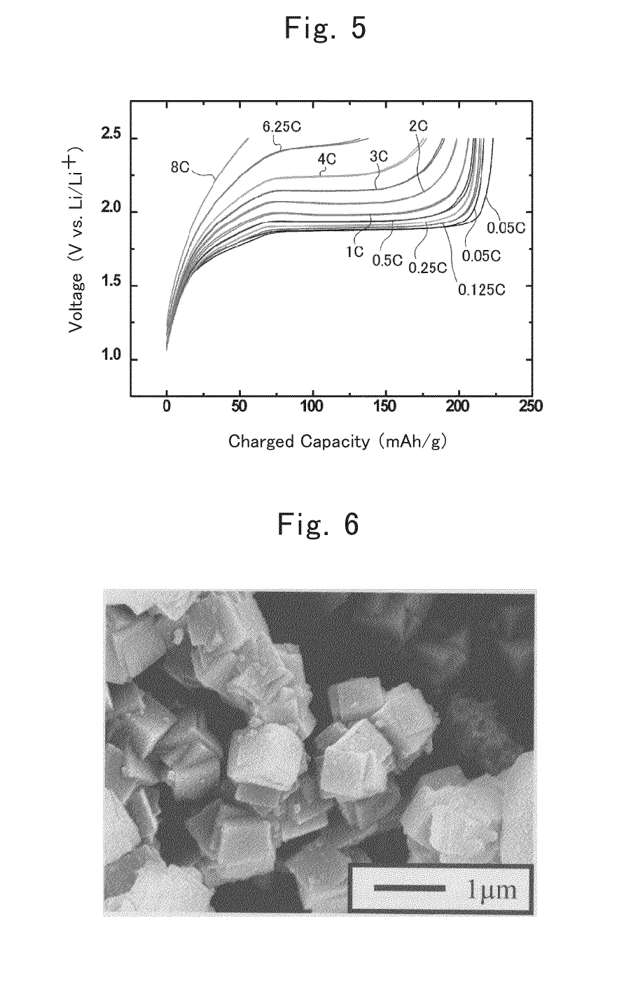

Rate characteristics of the lithium-ion secondary batteries according to the present example and Comparative Example No. 1 were measured. Specifically, repetitive charging and discharging operations were carried out while changing the electric current to be flowed as follows when let 1C=400 mA/g: 0.05C (i.e., 20 mA/g); 0.125C (i.e., 50 mA/g); 0.25C (i.e., 100 mA/g); 0.5C (i.e., 200 mA/g); 1C (i.e., 400 mA/g); 2C (i.e., 800 mA/g); 3C (i.e., 1,200 mA/g); 4C (i.e., 1,600 mA/g); 6C (i.e., 2,400 mA/g); and 8C (i.e., 3,200 mA/g). The cut-off voltage on this occasion was from 0.25 to 3.0 V. The temperature was 30° C. Results of the rate-characteristic test are illustrated in FIG. 4, and in FIG. 5. Note that FIG. 4 shows the rate characteristics of the lithium-ion secondary battery according to the present example, and FIG. 5 shows the rate characteristics of the lithium-ion secondary battery according to Comparative Example No. 1.

The lithium-ion secondary battery according to the present example had such a high capacity as 300 mAh/g even in a case where the C rate was such a considerably large rate as 8C. From this result, it is understood that the negative-electrode active material according to the present example enabled lithium-ion secondary batteries to be charge and discharge at a faster speed. On the contrary, the lithium-ion secondary battery according to Comparative Example No. 1 exhibited slightly small capacities, compared with those of the lithium-ion secondary battery according to the present example, even at identical electric-current densities. From this result, it is understood that using oxidized titanium fluoride, not simple titanium oxide, for a negative-electrode active material can make the rate characteristics of lithium-ion secondary batteries upgradable.

### Physical Properties of Negative-Electrode Active Material

The negative-electrode active material (i.e., oxidized titanium fluoride) according to the present example was analyzed using a scanning electron microscope (or SEM), a transmission electron microscope (or TEM), and X-ray diffraction (or XRD).

### SEM Analysis

An image of the negative-electrode active material according to the present example was taken by means of an SEM at a magnification of 20,000 times. An acceleration voltage on this occasion was 15 kV, and platinum was used for the coating. The resulting SEM image of the negative-electrode active material according to the present example is illustrated in FIG. 6.

As illustrated in FIG. 6, the negative-electrode active material according to the present example included secondary particles with substantially rectangular shapes (namely, substantially cubic shapes, and rectangular plate-like shapes), and primary particles with spherical shapes. The negative-electrode active material in this SEM image was extracted in a quantity of 10 pieces arbitrarily, and particle diameters of the respective negative-electrode active materials were measured using a ruler with reference to the length that is designated as 1 μm in FIG. 6. An average value was calculated for the negative-electrode active materials from the obtained lengths. As a result, an average particle diameter of the primary particles in the negative-electrode active material according to the present example was about 30 nm, and an average particle diameter of the secondary particles was less than 5 μm, and preferably less than 1 μm (that is, being nanometer-size particles as a whole).

### XRD Analysis

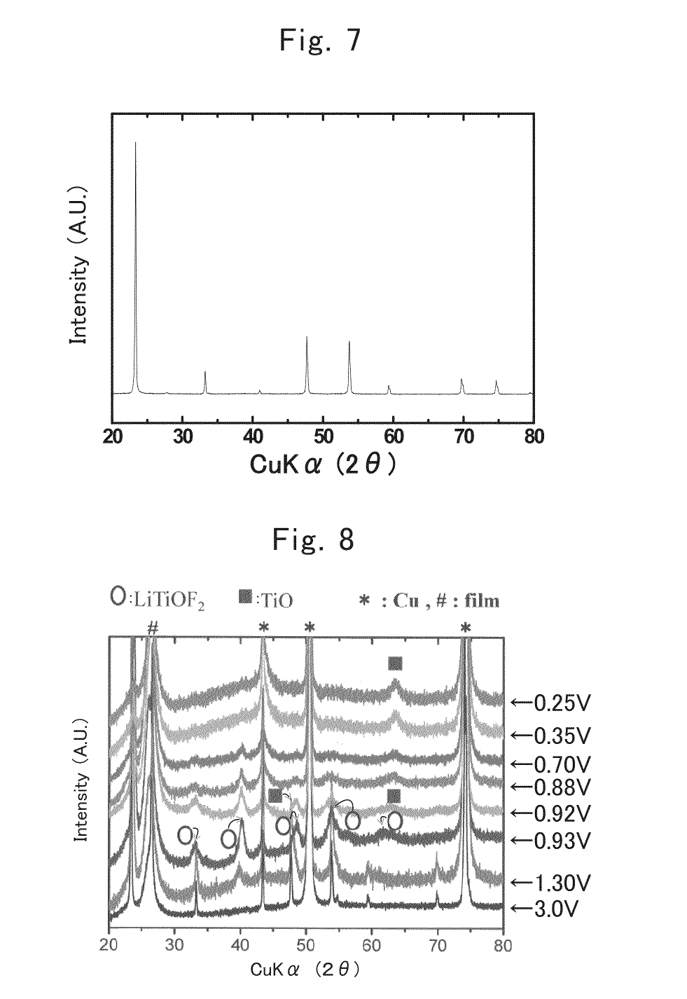

The negative-electrode active material according to the present example was subjected to an XRD analysis. An X-ray diffraction measurement was carried with use of the CuK_{α} ray by means of a powder X-ray diffractometer (e.g., a product of MAC Science Corporation, Model Number: MO6XCE) that served as an X-ray diffraction apparatus on this occasion. The measurement conditions were as follows: 40-kV voltage; 100-mA current; 4-degree/minute scanning rate; 0.02-degree sampling; one-time cumulated number; and the measurement range of from 15 to 80 degrees by diffraction angle (2θ). Results of the XRD are illustrated in FIG. 7. As illustrated in FIG. 7, broad peaks were ascertained which had peak positions at around 23.6 degrees, 33.5 degrees, 53.4 degrees 59.1 degrees, 69.5 degrees, and 74.2 degrees in a range where the diffraction angle (2θ) was from 15 to 80 degrees.

Note that, as a result of subjecting the anatase-type TiO₂, which had been used as a raw material for the negative-electrode active material in the present example, to an XRD analysis and then referring the resulting analyzed results to that of the JCPDS card (i.e., #21-1272), this anatase-type TiO₂, that is, a synthesized substance which was obtained by means of a uniform precipitation method and hydrothermal method, was ascertained to belong to the “anatase-type TiO₂.”

### Structural Changes of Negative-Electrode Active Material in Battery

### XRD Analysis

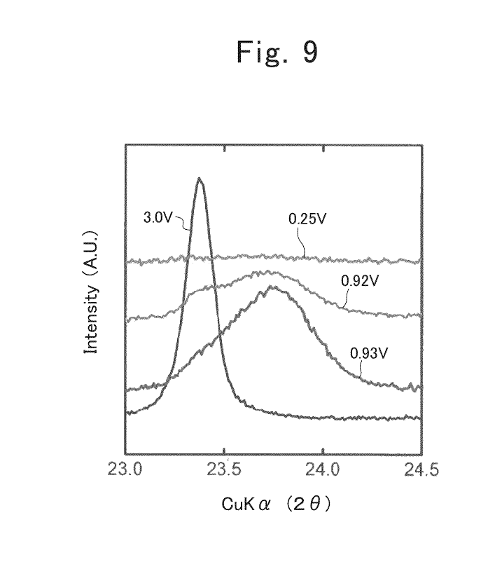

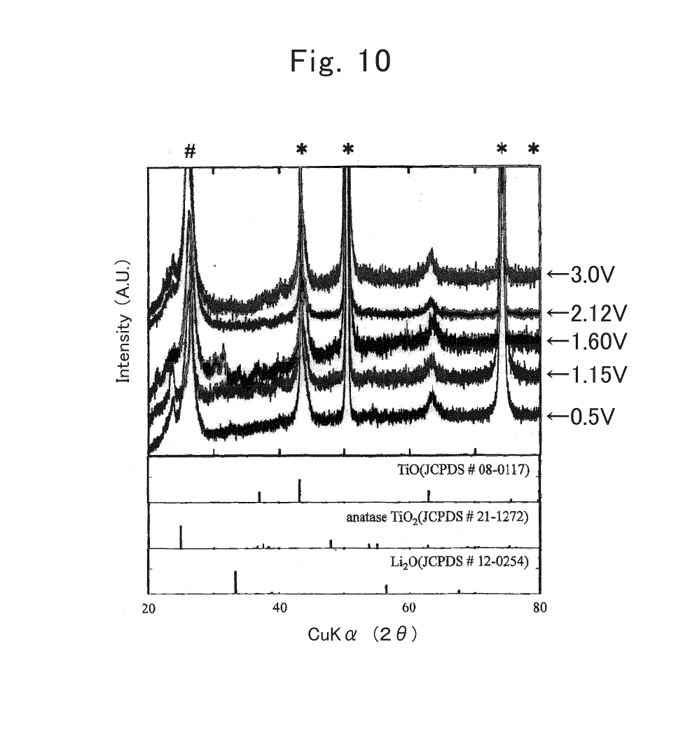

By means of XRD (e.g., ex-situ XRD), structural changes of the negative-electrode active material in the lithium-ion secondary battery according to the present example were analyzed at the time of the first-round discharging, and at the time of the first-round charging. Results of the XRD at the time of the first-round discharging are illustrated in FIG. 8, and in FIG. 9. Results of the XRD at the time of the first-round charging are illustrated in FIG. 10.

As illustrated in FIG. 8, the lithium-ion secondary battery according to the present example was discharged gradually in the following order: 3.0 V--->1.30 V--->0.93 V--->0.92 V--->0.88 V--->0.70 V--->0.35 V--->0.25 V, and structures of the negative-electrode active material were then subjected to the XRD analysis at the respective stages. Moreover, as illustrated in FIG. 10, the post-first-round-discharging lithium-ion secondary battery according to the present example was charged gradually in the following order: 0.5 V--->1.15 V--->1.60 V--->2.12 V--->3.0 V, and structures of the negative-electrode active material were then subjected to the XRD analysis at the respective stages. And, compounds being included in the negative-electrode active material at the respective stages were identified by referring these analyzed results of the XRD to those of the JCPDS card (i.e., #21-1272 for anatase-type TiO₂; #08-0117 for TiO; and #12-0254 for Li₂O). With regard to LiTiOF₂, the identification was made by means of the space group “R3c.”

As illustrated in FIG. 8, although the peak of LiTiOF₂ was ascertained in the initial period of the discharging, this peak disappeared in the later periods of the discharging. Instead of that, the peak of TiO, which had not been appreciated in the initial period of the discharging, arose over a period of from the intermediate periods of the discharging to the later periods. As illustrated in FIG. 10, this peak of LiTiOF₂ did not appear at the time of the first-round charging. In addition, as illustrated in FIG. 8, a peak at around 60 degrees, which belongs to LiTiO₂, appeared in the terminal period of the discharging. As illustrated in FIG. 10, this peak of LiTiO₂ augmented at the time of the charging.

In addition, as illustrated in FIG. 9, namely, an enlarged diagram for some of the major sections, a half-value width of the negative-electrode active material became greater as the discharging proceeded in the following order: 3.0 V--->0.93 V--->0.92 V--->0.25 V. Consequently, it is presumed that the negative-electrode active material, which had been crystalline in the initial period of the discharging, was turned into the form of amorphous partially at least in the terminal period of the discharging.

### XPS Analysis

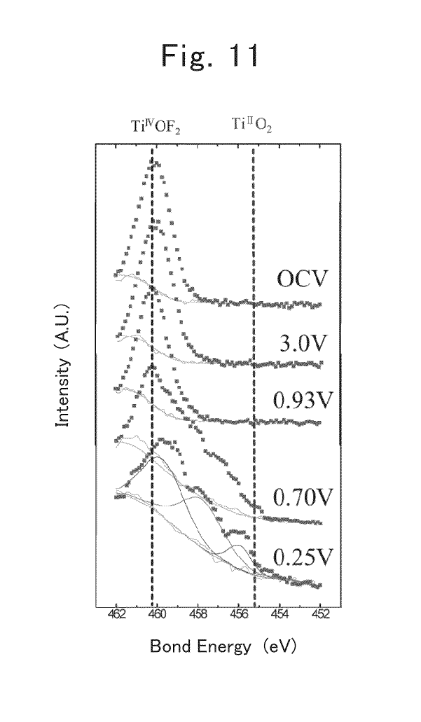

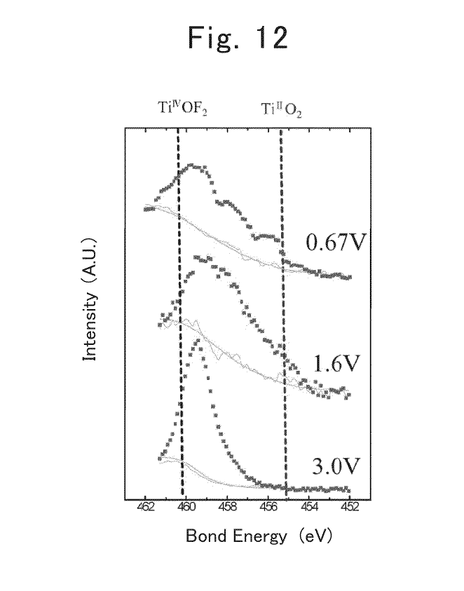

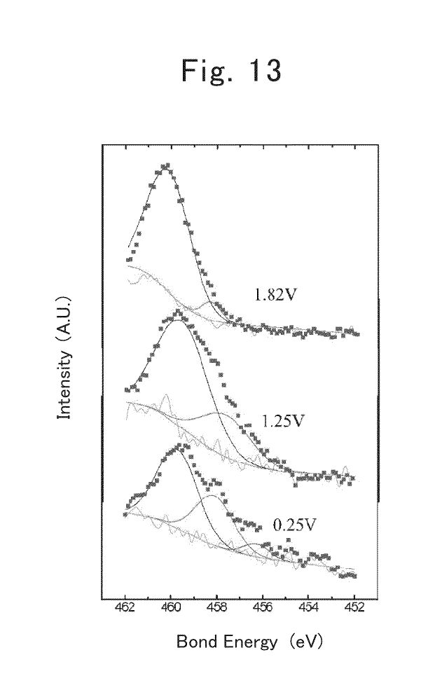

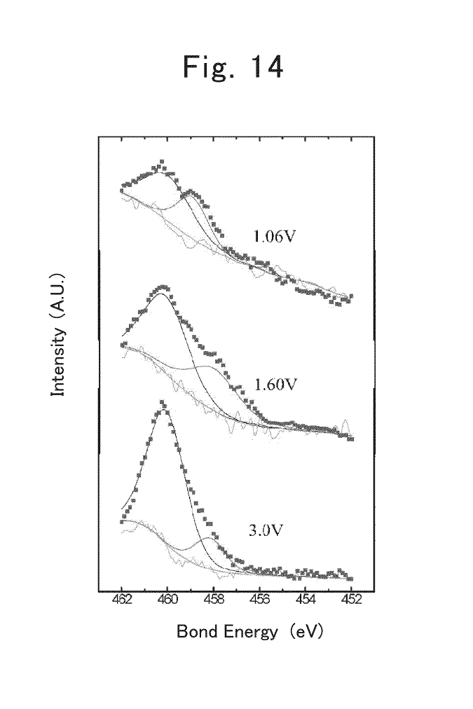

By means of XPS (e.g., XPS in ex-situ mode by “5600,” a product of ULVAC-PHI), structural changes of the negative-electrode active material in the lithium-ion secondary battery according to the present example were analyzed at the time of the first-round discharging, at the time of the first-round charging, at the time of the second-round discharging, and at the time of the second-round charging. To be concrete, “Ti2p” spectra on the negative electrode resulting from the XPS were analyzed. Results of the XPS analysis at the time of the first-round discharging are illustrated in FIG. 11. Results of the XPS analysis at the time of the first-round charging are illustrated in FIG. 12. Results of the XPS analysis at the time of the second-round discharging are illustrated in FIG. 13. Results of the XPS analysis at the time of the second-round charging are illustrated in FIG. 14.

As illustrated in FIG. 11 through FIG. 14, it is understood from the results of the XPS measurement that, although the valency of Ti decreased (that is, decreased to trivalent and divalent Ti) at the time of the first-round discharging as the discharging reaction of TiOF₂ advanced, the valency of Ti did not become zero even when the discharging reaction arrived at the end point. The valency of Ti at the endpoint of the charging reaction was tetravalent equally in the first-round cycle, and in the second-round cycle.

As being mentioned above, from the results of the XRD (e.g., FIG. 8), the peak being inherent to TiOF₂ decreased over the periods of from the initial period of the discharging to the intermediate period (i.e., from 3.0 V to 0.93 V), and disappeared (or disappeared virtually) thereafter. When taking these into consideration, it is presumed that the intercalation of lithium proceeded in the initial period of lithiation, and that the conversion reaction proceeded along the plateau at the potentials of 0.93 V or less. Moreover, from the results of the XRD likewise, the peak at around 60 degrees, which belonged to LiTiO₂, was detected from 0.35 V at the time of discharging (FIG. 8), and this peak augmented at the time of charging (FIG. 10). From these results, it was presumed that, in the reaction mechanism of TiOF₂, the intercalation reaction proceeded in the initial period of discharging; the conversion reaction to LiTiO₂ then followed to occur subsequently; and the newly generated LiTiO₂ caused the intercalation reaction to occur in the initial charging reaction or later.

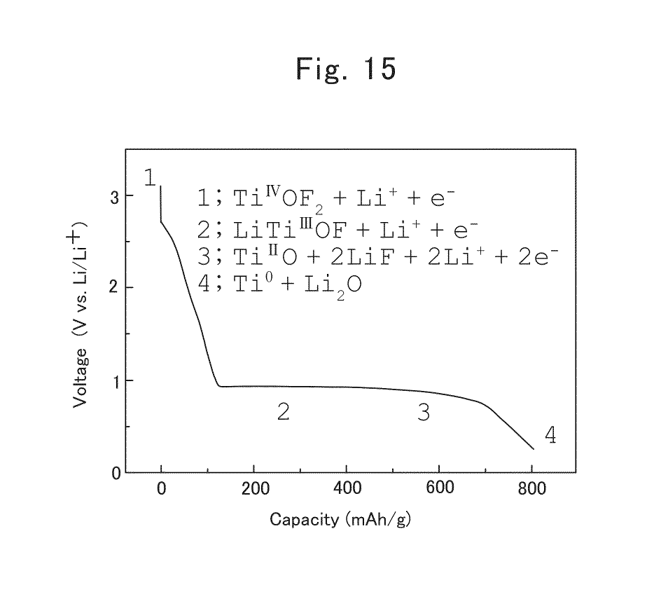

When applying this result to one of the discharging curves of the lithium-ion secondary battery, the Ti and F in the negative-electrode active material exist in the state of Ti^{IV}OF₂+Li⁺+e⁻ in Initial Period “1” of the discharging (i.e., in the vicinity of from 3 V to 1 V, and in the vicinity of from 0 to 100 mAh/g), as illustrated in FIG. 15. And, it is believed that they are in the state of LiTi^{III}OF+Li⁺+e⁻ in Intermediate Period “2” of the discharging (i.e., in the vicinity of 1 V, and in the vicinity of from 100 to 400 mAh/g). It is believed that they are in the state of Ti^{II}O+2LiF+2Li⁺+e⁻ in Later Period “3” of the discharging (i.e., in the vicinity of 1 V, and in the vicinity of from 400 to 700 mAh/g), and that at least a part of them are in the state of Ti⁰+2LiF+Li₂O in Terminal Period “4” of the reaction (i.e., at less than 1 V, and in the vicinity of from 700 to 800 mAh/g). And, it is believed that, in the first-round charging and discharging or later, the following reversible reactions are repeated: Ti^{IV}O₂+2Li⁺+2e⁻<------>Ti^{II}O+2LiF+2Li⁺+e⁻<------>Ti⁰+2LiF+Li₂O. In other words, it is believed that oxidized titanium fluoride (e.g., TiOF₂), which serves as a negative-electrode active material, reacts irreversibly at the time of the first-round discharging so that titanium oxide (e.g., TiO) arises. This is supported by the above-mentioned results of the XRD.

Note that, in oxidized titanium fluoride (e.g., TiOF₂), 2-mol fluorine (F) is included with respect to 1-mol titanium (Ti). Since the molar ratios of the Ti and F do not change after charging and discharging, it is possible to say 2-mol fluorine (F) is included with respect to 1-mol titanium (Ti) in the negative-electrode active material according to the present example. In other words, it is believed that the negative-electrode active material according to the present example gave the above-described better charged and discharged capacities to the lithium-ion secondary battery and enabled it to charge and discharge at a faster speed because of including 2-mol fluorine (F) with respect to 1-mol titanium (Ti). Note that, as far as fluorine (F) is included in an amount exceeding 1 mol with respect to 1-mol titanium (Ti), it is possible to say that at least a part of the resulting negative-electrode active material acts as the above-mentioned negative-electrode active material. In other words, it is advisable that, in the negative-electrode active material according to the present invention, fluorine (F) can be included in an amount exceeding 1 mol with respect to 1-mol titanium (Ti).

### Crystal Structures of Negative-Electrode Active Material in Battery

The negative-electrode active material according to the present example was subjected to a TEM analysis in the respective stages at the time of the first-round discharging. Crystal structures of the negative-electrode active material in the respective stages at the time of the first-round discharging were observed by means of this analysis.

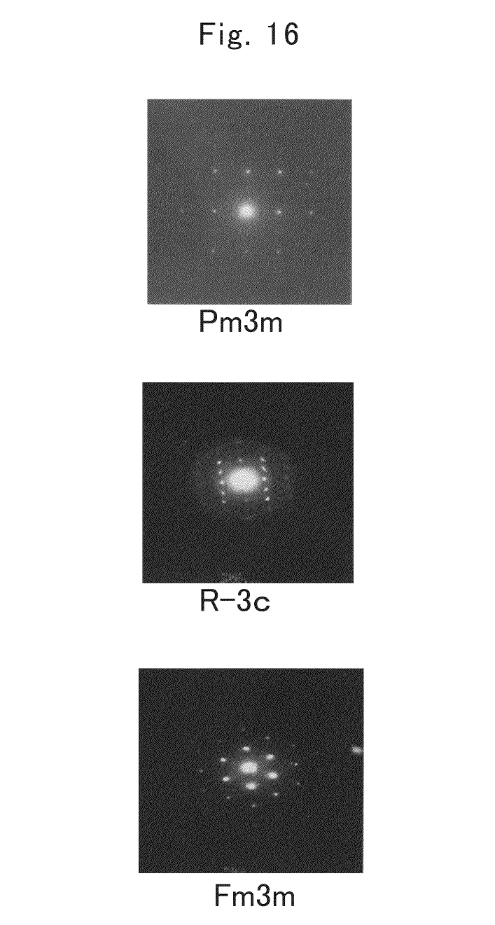

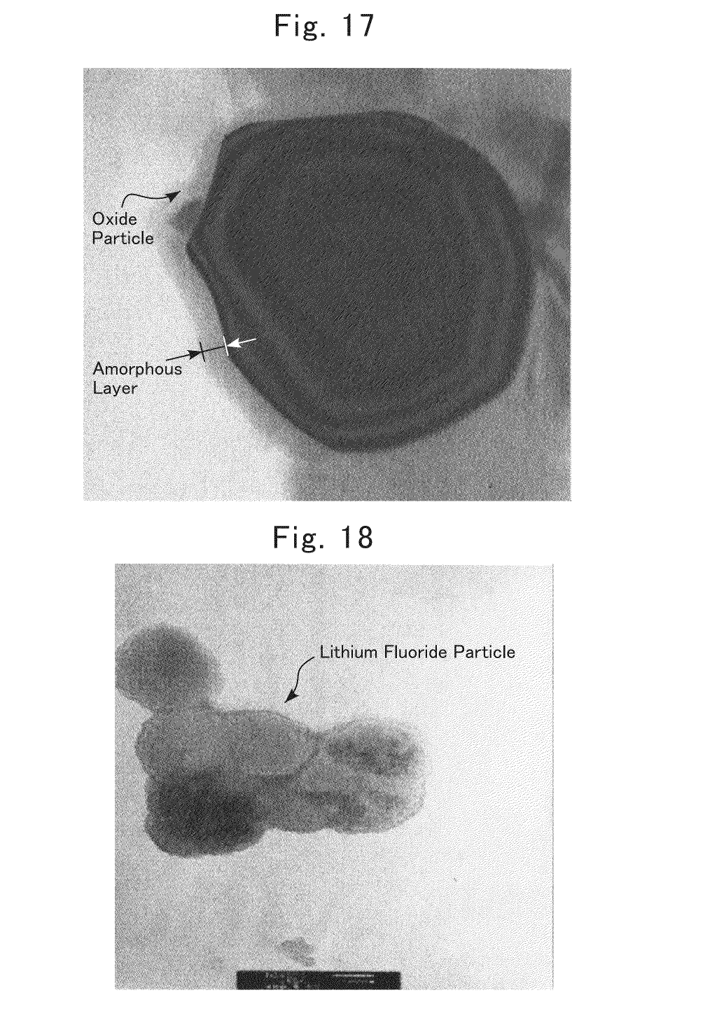

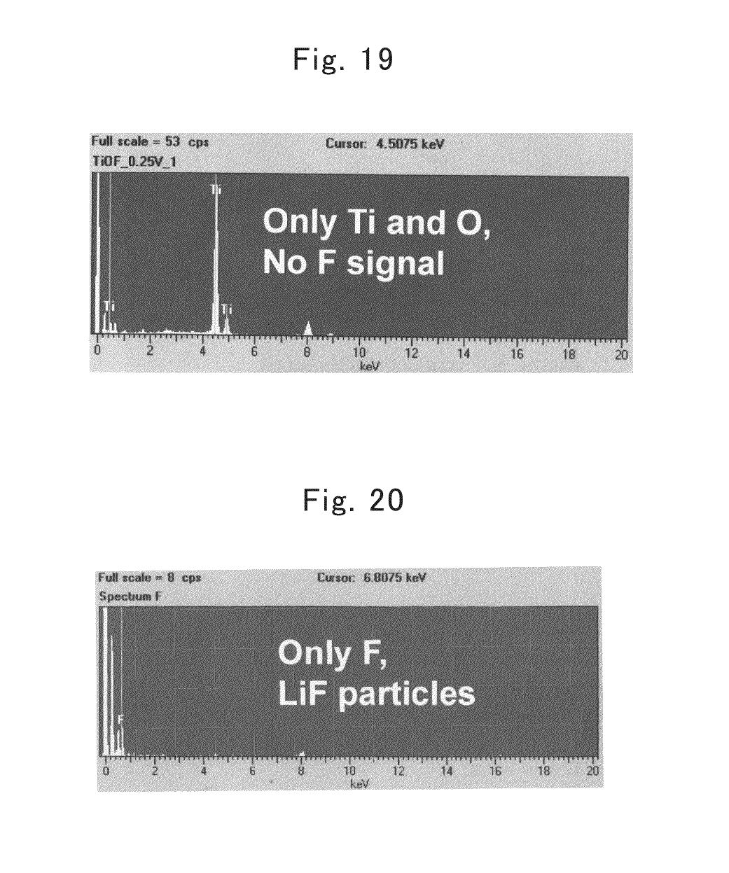

Specifically, images of the negative-electrode active were taken by means of an electron diffraction method in the following respective stages at the time of the first-round discharging: Initial Period “A” of the discharging at 3 V; Intermediate Period “B” of the discharging at 0.93 V; and Terminal Period “C” of the discharging at 0.25V. Moreover, images of the negative-electrode active material in Terminal Period “C” of the discharging were taken by mean of a TEM. In addition, the negative-electrode active material in Terminal Period “C” of the discharging was subjected to an elemental analysis by means of EDX. The resulting electron-diffraction images are illustrated in FIG. 16. More specifically, the electron-diffraction image of the negative-electrode active material in Initial Period “A” of the discharging at 3 V is illustrated at the top in FIG. 16; the electron-diffraction image of the negative-electrode active material in Intermediate Period “B” of the discharging at 0.93V is illustrated at the middle in FIG. 16; and the electron-diffraction image of the negative-electrode active material in Terminal Period “C” of the discharging at 0.25 V is illustrated at the bottom in FIG. 16. Moreover, the resultant TEM images are illustrated in FIGS. 17 and 18, and results of the EDX are illustrated in FIGS. 19 and 20.

As illustrated at the top in FIG. 16, a crystal structure was ascertained in the negative-electrode active material in Initial Period “A” of the discharging. As described above, it is believed that the negative-electrode active material was TiOF₂ particles in Initial Period “A” of the discharging. As illustrated at the middle and bottom in FIG. 16, it is believed that the crystal structure of the negative-electrode active material collapsed gradually as the discharging proceeded at the time of the first-round discharging. And, as illustrated in FIG. 17, it is believed that a part of the negative-electrode active material turned into the form of amorphous in Terminal Period “C” of the discharging. It is believed that oxidized titanium fluoride in the negative-electrode active material turned into LiTiOF₂ particles, because Li had entered the negative-electrode active material in intermediate period of the discharging. As described above, it is believed that the negative-electrode active material was separated into the following: oxide particles, not including fluorine (F) but including titanium (Ti), (see FIG. 17); and lithium fluoride particles, including fluorine (F), (see FIG. 18), because fluorine had eliminated from the oxidized titanium fluoride in Terminal Period “C” of the discharging. As illustrated in FIG. 17, an amorphous layer was formed on the surface of the oxide particles, and the crystal structure was kept inside the oxide particles. It is believed that the interior and amorphous layer of the oxide particles were constituted of titanium oxide (e.g., TiO and/or TiO₂) mainly. It is believed that Li₂O went into the interior of this negative-electrode active material. Note that it is believed that the lithium fluoride particles in the negative-electrode active material did not contribute to the charging and discharging, because the reaction in which the lithium fluoride particles generated is believed to be the conversion reaction, namely, an irreversible reaction, as described above.

As illustrated in FIG. 19, only TiO and O were detected from the oxide particles in FIG. 17, but no F was detected therefrom. Moreover, as illustrated in FIG. 20, only F was detected from the lithium fluoride particles in FIG. 18, but no Ti was detected therefrom. Note that it is presumed that, although lithium (Li) could not be detected by the EDX, Li was included in the lithium fluoride grains, and that it is believed that Li was also included in the oxide particles, too, as far as not being charged completely.

Note that it is allowable that the amorphous layer can be formed on at least a part of the surfaces of the oxide particles, so that such a case might possibly arise where it is formed on a part of the surfaces of the oxide particles alone. Moreover, in the negative-electrode active material according to the present invention, it is even permissible that all of the oxide particles do not necessarily possess the amorphous layer.

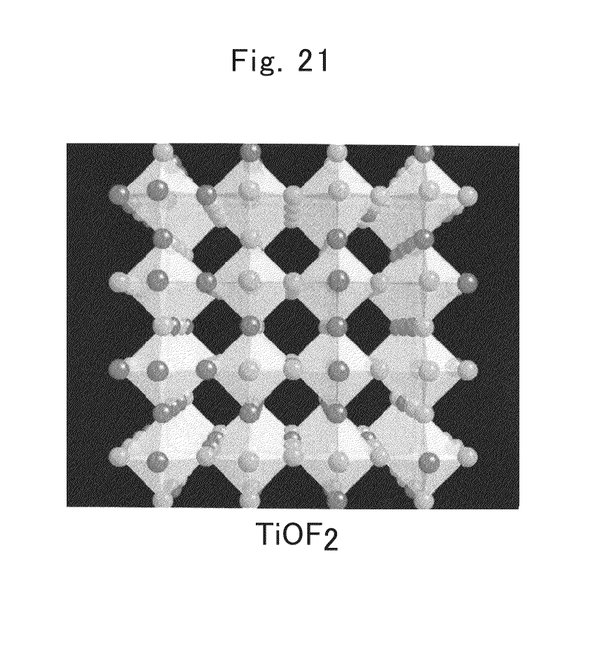

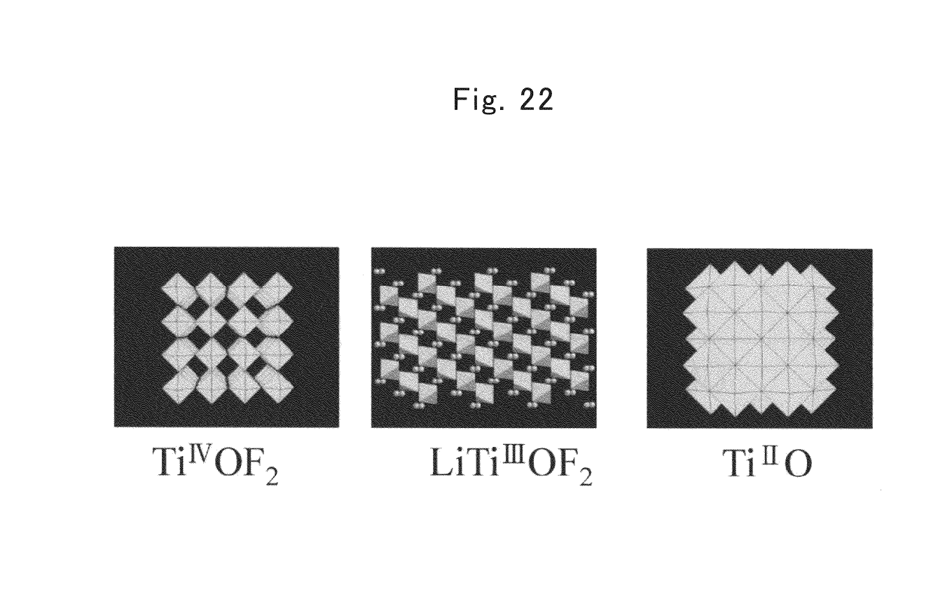

For reference, it is believed that TiOF₂ in the negative-electrode active material possessed the crystal structure that is illustrated in FIG. 21. Moreover, it is believed that Ti^{IV}OF₂, LiTi^{III}OF₂ and Ti^{II}O in the negative-electrode active material possessed the crystal structures that are illustrated in FIG. 22, respectively.

1. A negative-electrode active material for lithium-ion secondary battery being characterized in that:
the negative-electrode active material includes titanium (Ti), and fluorine (F); and
a content of fluorine (F) per 1-mol titanium (Ti) exceeds 1 mol.

2. The negative-electrode active material for lithium-ion secondary battery as set forth in claim 1, wherein the content of fluorine (F) per 1-mol titanium (Ti) is 2 mol or more.

3. The negative-electrode active material for lithium-ion secondary battery as set forth in claim 1, wherein:
the negative-electrode active material includes, after the first-round charging/discharging or later, said titanium (Ti) as oxide particles, and includes said fluorine (F) as lithium fluoride particles; and
an amorphous layer exists on a surface of at least a part of the oxide particles.

4. The negative-electrode active material for lithium-ion secondary battery as set forth in claim 1, wherein the negative-electrode active material includes, after the first-round charging/discharging or later, titanium oxide (TiO).

5. A lithium-ion secondary battery being characterized in that the lithium-ion secondary battery includes the negative-electrode active material for lithium-ion secondary battery as set forth in claim 1 in a negative electrode.

6. A vehicle being characterized in that the vehicle has the lithium-ion secondary battery as set forth in claim 5 on-board.

7. A process for producing a negative-electrode active material for lithium-ion secondary battery being characterized in that:
the process is equipped with a heating step of obtaining oxidized titanium fluoride by heating a mixed raw material, which includes a mixture of anatase-type TiO2 and hydrofluoric acid, at 70° C. or more; and
the mixed raw material includes hydrogen fluoride (HF) in an amount exceeding 2 mol for each 1 mol of the anatase-type TiO2.

8. The process for producing a negative-electrode active material for lithium-ion secondary battery as set forth in claim 7, wherein said mixed raw material includes hydrogen fluoride (HF) in an amount of 10 mol or more for each 1 mol of said anatase-type TiO2.

9. The process for producing a negative-electrode active material for lithium-ion secondary battery as set forth in claim 7, wherein said heating step is done at 80° C. or more.

10. The process for producing a negative-electrode active material for lithium-ion secondary battery as set forth in claim 7, the process being further equipped with, before said heating step, a stifling step of stifling said mixed raw material for 10 hours or more.

11. A process for manufacturing a lithium-ion secondary battery being characterized in that the oxidized titanium fluoride, which is produced by the process for producing a negative-electrode active material for lithium-ion secondary battery as set forth in claim 7, is used as a negative-electrode active material.

12. A negative-electrode active material for lithium-ion secondary battery being characterized in that:
the negative-electrode active material is produced by the process for producing a negative-electrode active material for lithium-ion secondary battery as set forth in claim 7;
the negative-electrode active material includes titanium (Ti), and fluorine (F); and
a content of fluorine (F) per 1-mol titanium (Ti) exceeds 1 mol.

13. The negative-electrode active materials for lithium-ion second battery as set forth in claim 1, wherein the negative-electrode active materials contains primary particles and second particles, and wherein an average particle diameter of the secondary particles is less than 5 μm.
